(19) United States
(12) Patent Application Publication
(10) Pub. No.: US 2026/0121769 A1
(43) Pub. Date: Apr. 30, 2026

(54) SELF-INTERFERENCE CANCELLATION DEVICE, WIRELESS COMMUNICATIONS DEVICE INCLUDING THE SAME, AND METHOD

(71) Applicant: Samsung Electronics Co., Ltd., Suwon-si (KR)

(72) Inventors: Yoonsuk OH, Suwon-si (KR); Hongmin CHOI, Suwon-si (KR); Hyung Sun LIM, Suwon-si (KR); Myeonggyun CHOI, Suwon-si (KR); Joonhoi HUR, Suwon-si (KR)

(73) Assignee: Samsung Electronics Co., Ltd., Suwon-si (KR)

(21) Appl. No.: 19/368,748

(22) Filed: Oct. 24, 2025

(30) Foreign Application Priority Data
Oct. 28, 2024 (KR) 10-2024-0148772

(51) Int. Cl. H04B 15/02

(52) U.S. Cl. CPC H04B 15/02

(57) ABSTRACT

A self-interference cancellation device includes processing circuitry configured to acquire a plurality of nonlinear bases from a transmit signal, select a subset including at least a portion of the plurality of nonlinear bases, acquire a plurality of orthogonal nonlinear bases based on performing orthogonalization on the subset, estimate a self-interference signal based on the plurality of orthogonal nonlinear bases, and cancel the self-interference signal from a receive signal.

### CROSS-REFERENCE TO RELATED APPLICATION(S)

This U.S. non-provisional application claims priority under 35 USC § 119 to Korean Patent Application No. 10-2024-0148772, filed on Oct. 28, 2024, in the Korean Intellectual Property Office, the disclosure of which is herein incorporated by reference in its entirety.

### BACKGROUND

Example embodiments relate to a self-interference cancellation device, a wireless communications device including the same, and a method.

In a wireless communication system, a transmit signal transmitted by a base station or terminal typically has a higher power, while a receive signal reaching a receiving antenna has a lower power level than the transmit signal. In a wireless communication system in which a gap between a transmit band and a receive band is shorter, or in which a transmit band and a receive band may overlap each other, the spectral emission of a relatively high-power transmit signal may act as self-interference on a receive signal.

Spectral emission may result from a device having nonlinearity in the wireless communication system or a configuration including such a device (for example, a power amplifier (PA), or the like). Out-of-band (OOB) emissions, which may be regarded as emissions outside a predetermined (or alternatively, given) band, may reach the receiving side in spite of filtering and act as self-interference. Self-interference on the receiving side, caused by the transmit signal, may significantly degrade reception performance.

### SUMMARY

Example embodiments provide a self-interference cancellation device capable of cancelling self-interference from a receive signal, a wireless communications device including the same, and a method.

According to example embodiments, a self-interference cancellation device includes processing circuitry configured to acquire a plurality of nonlinear bases from a transmit signal, select a subset including at least a portion of the plurality of nonlinear bases, acquire a plurality of orthogonal nonlinear bases based on performing orthogonalization on the subset, estimate a self-interference signal based on the plurality of orthogonal nonlinear bases, and cancel the self-interference signal from a receive signal.

According to example embodiments, a method includes acquiring a plurality of nonlinear bases from a transmit signal, selecting a subset including at least a portion of the plurality of nonlinear bases, acquiring a plurality of orthogonal nonlinear bases based on performing orthogonalization on the subset, estimating a self-interference signal based on the plurality of orthogonal nonlinear bases, and canceling the self-interference signal from a receive signal.

According to example embodiments, a wireless communications device includes a front-end module (FEM) configured to separate a transmit channel and a receive channel, transmit a transmit signal through the transmit channel, and receive a receive signal through the receive channel, a radio-frequency integrated chip (RFIC) configured to perform frequency conversion and analog-to-digital conversion on the transmit signal and the receive signal, and processing circuitry configured to acquire a plurality of nonlinear bases from the transmit signal, the transmit signal being a digital signal, select a subset including at least a portion of the plurality of nonlinear bases, acquire a plurality of orthogonal nonlinear bases based on performing orthogonalization on the subset, estimate a self-interference signal based on the plurality of orthogonal nonlinear bases, and cancel the self-interference signal from the receive signal, the receive signal being a digital signal.

According to example embodiments, a non-transitory computer-readable medium stores instructions that, when executed by processing circuitry of a self-interference cancellation device, cause the self-interference cancellation device to perform a method, the method including acquiring a plurality of nonlinear bases from a transmit signal, selecting a subset including at least a portion of the plurality of nonlinear bases, acquiring a plurality of orthogonal nonlinear bases based on performing orthogonalization on the subset, estimating a self-interference signal based on the plurality of orthogonal nonlinear bases, and canceling the self-interference signal from a receive signal.

### BRIEF DESCRIPTION OF DRAWINGS

FIG. 1 is a block diagram of a wireless communications device according to example embodiments.

FIG. 2 is a block diagram illustrating a more detailed example of the wireless communications device of FIG. 1.

FIG. 3 is a diagram illustrating an example of a nonlinear system.

FIG. 4 is a block diagram of a self-interference cancellation device according to example embodiments.

FIG. 5 is a block diagram of an orthogonal nonlinear basis acquisition circuit included in a self-interference cancellation device according to example embodiments.

FIG. 6 is a waveform diagram illustrating the operation of an orthogonal nonlinear basis acquisition circuit according to example embodiments.

FIG. 7 is a block diagram of a self-interference cancellation device according to example embodiments.

FIG. 8 is a block diagram of a synchronization circuit of FIG. 7 according to example embodiments.

FIG. 9 is a block diagram of a self-interference cancellation circuit according to example embodiments.

FIG. 10 is a block diagram of a self-interference cancellation device according to example embodiments.

FIG. 11 is a flowchart illustrating a method of a self-interference cancellation device according to example embodiments.

FIG. 12 is a flowchart illustrating a synchronization method according to example embodiments.

FIG. 13 is a block diagram of a device according to example embodiments.

### DETAILED DESCRIPTION

Hereinafter, example embodiments will be described with reference to the accompanying drawings.

Some terms that may be commonly used throughout the present disclosure may be defined, as follows:
complex baseband equivalent: a complex representation or complex value of a baseband signal before passing through a filter in a communication system, and
nonlinear basis or nonlinear basis function (hereinafter, collectively referred to as nonlinear basis): a basic function for representing a nonlinear space or a nonlinear model. Each nonlinear basis has an arbitrary order l (where l is a positive integer).

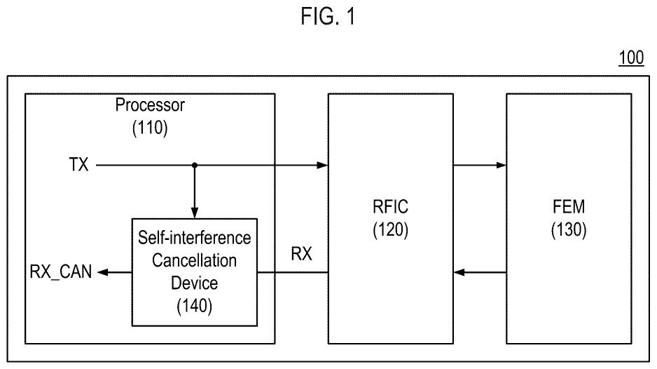

FIG. 1 is a block diagram of a wireless communications device according to example embodiments.

Referring to FIG. 1, a wireless communications device 100 according to example embodiments may include a processor 110, a radio-frequency integrated chip (RFIC) 120, and/or a front-end module (FEM) 130.

The processor 110, the RFIC 120, and the FEM 130 included in the wireless communications device 100 may be individually implemented as ICs, chips, or modules. In addition, the processor 110, the RFIC 120, and the FEM 130 may be mounted together on a printed circuit board (PCB). However, example embodiments are not limited thereto. In example embodiments, at least a portion of the processor 110, the RFIC 120, and the FEM 130 may be implemented as a single communication chip.

Furthermore, the wireless communications device 100 illustrated in FIG. 1 may be included in a wireless communications system using a cellular network such as 6th-generation (6G), 5th-generation (5G), long term evolution (LTE), or may be included in a wireless local area network (WLAN) system or any other wireless communications system. For reference, the configuration of the wireless communications device 100 illustrated in FIG. 1 is only an example and example embodiments are not limited thereto, and the wireless communications device 100 may be configured in various ways depending on a communications protocol or a communications scheme.

The processor 110 may process a transmit signal TX including information to be transmitted or process a receive signal RX in a digital domain. For example, the processor 110 may be referred to as a modem.

The RFIC 120 may perform frequency conversion and analog-to-digital conversion on the transmit signal TX and the receive signal RX. For example, the RFIC 120 may perform up-conversion on the transmit signal TX or down-conversion on the receive signal RX. The RFIC 120 may convert a transmit signal TX in a digital domain, processed by the processor 110, into an analog domain, or convert a receive signal RX in an analog domain, output from the FEM 130, into a digital domain.

The FEM 130 may separate a transmit channel and a receive channel, transmit the transmit signal TX through the transmit channel, and receive the receive signal RX from the receive channel. For example, the FEM 130 may be implemented based on a duplexer or a switch structure that may separate each channel.

In example embodiments, the RFIC 120 may amplify the transmit signal TX or perform low-noise amplification on the receive signal RX. Alternatively, in example embodiments, the FEM 130 may amplify the transmit signal TX or perform low-noise amplification on the receive signal RX. The RFIC 120 or the FEM 130 according to example embodiments may include a power amplifier PA and a low-noise amplifier (LNA) to perform amplification.

An amplifier such as the PA and LNA may have nonlinearity (for example, nonlinearity caused by a nonlinear element when the amplifier includes the nonlinear element). The transmit signal TX may be distorted due to the nonlinearity of the PA, and the distortion may cause out-of-band (OOB) emission in adjacent channels. The intensity of OOB emissions is based on the power intensity of the transmit signal TX, so that the OOB emissions may affect the performance of the receive signal RX having lower power than the transmit signal TX. For example, the OOB emission may act as self-interference on the receive signal RX in the wireless communications device 100.

A signal that may be considered self-interference, for example, a self-interference signal, may be regarded as an output signal for a nonlinear system (for example, the RFIC 120 or the FEM 130 including the PA) of the transmit signal TX.

The processor 110 according to example embodiments may include a self-interference cancellation device 140 configured to cancel self-interference. Hereinafter, the transmit signal TX provided to the self-interference cancellation device 140 may be a signal processed in the digital domain by the processor 110. For example, the “process” provided by the processor 110 for the transmit signal TX may include coding, mapping, modulation, Fourier transform, cyclic prefix (CP) insertion, filtering, or the like.

The self-interference cancellation device 140 according to example embodiments may obtain a plurality of nonlinear bases from the transmit signal TX and select a subset including at least a portion of the plurality of nonlinear bases. At least a portion of the nonlinear bases may be nonlinear bases acting as self-interference on the receive signal RX. When the plurality of nonlinear bases are defined to have orders from 1 to K (where K is a positive integer), at least a portion of the nonlinear bases may have an order k (where k is an arbitrary order, among positive integers less than or equal to K).

The self-interference cancellation device 140 may obtain a plurality of orthogonal nonlinear bases, based on performing orthogonalization on the selected subset. The orthogonalization may be performed only on at least a portion of the nonlinear bases having orders corresponding to the selected subset.

By performing the orthogonalization operation, at least a portion of the nonlinear bases included in the selected subset may be converted into mutually orthogonal nonlinear bases. The converted orthogonal nonlinear bases may have a reduced or eliminated correlation, compared to the nonlinear bases before conversion.

The self-interference cancellation device 140 may estimate the self-interference signal based on the plurality of orthogonal nonlinear bases and cancel the self-interference signal from the receive signal RX. The self-interference cancellation device 140 may output a receive signal RX_CAN from which the self-interference signal has been canceled.

The wireless communications device 100 according to the above-described examples may improve reception performance by cancelling self-interference on the receive signal RX through the self-interference cancellation device 140. For example, the wireless communications device 100 may reduce or eliminate correlation between nonlinear bases and reduce computational complexity by selecting nonlinear bases, acting as self-interference, as a subset and performing orthogonalization only on the selected subset.

Even in a communication environment in which self-interference may be intensified, such as an in-band full duplex or a sub-band full duplex, reception performance may be improved through the estimation and removal of the self-interference signal.

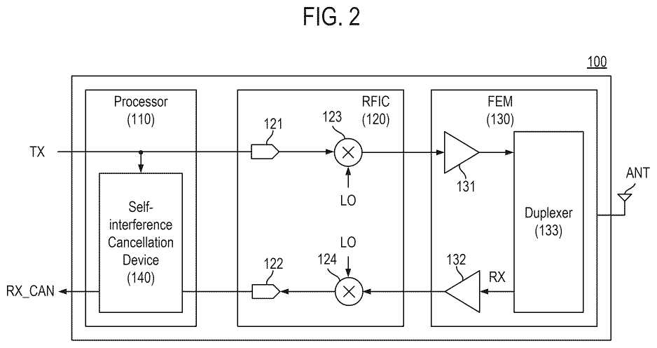

FIG. 2 is a block diagram illustrating a more detailed example of the wireless communications device of FIG. 1.

Referring to FIG. 2, the processor 110 may process the transmit signal TX in the digital domain and output the processed transmit signal TX to the RFIC 120. Alternatively, the processor 110 may process the receive signal RX in the digital domain.

The RFIC 120 may include a digital-to-analog converter (DAC) 121, an analog-to-digital converter (ADC) 122, a first mixer 123, and/or a second mixer 124. At least one DAC 121 and at least one ADC 122 may be provided. The FEM 130 may include a PA 131, an LNA 132, and/or a duplexer 133. In FIG. 2, the PA 131 and the LNA 132 are illustrated as being included in the FEM 130, but example embodiments are not limited thereto. For example, the PA 131 and the LNA 132 may be included in the RFIC 120.

A transmit path is described first. The DAC 121 may perform analog conversion on a baseband transmit signal TX. The first mixer 123 may perform frequency up-conversion to convert a frequency of the analog-converted transmit signal TX from a baseband to a high-frequency band through a frequency signal provided by a local oscillator LO.

The PA 131 may receive a DC voltage or a variable power supply voltage (for example, a dynamically varying output voltage) and secondarily amplify the power of the up-converted transmit signal TX based on the supplied power supply voltage. The PA 131 may provide the amplified transmit signal TX to the duplexer 133. However, as described above, OOB emissions may occur during the amplification due to the nonlinearity of the PA 131. Even after passing through the duplexer 133, a portion of the OOB emissions may reach the LNA 132. The OOB emissions reaching the LNA 132 may act as self-interference.

For reference, the wireless communications device 100 may transmit the transmit signal TX through a plurality of frequency bands using carrier aggregation (CA). To this end, the wireless communications device 100 may also include a plurality of PAs 131, each performing power amplification on a plurality of transmit signals TX, respectively corresponding to a plurality of carriers. For ease of description, an example with a single PA 131 is provided.

The duplexer 133 may be connected to an antenna ANT to separate the transmit frequency and the receive frequency. For example, the duplexer 133 may separate the amplified transmit signal TX, provided from the PA 131, for each frequency band and provide the separated transmit signal TX to a corresponding antenna ANT.

For reference, the wireless communications device 100 may be provided with a switch structure that may separate the transmit frequency and the receive frequency, instead of the duplexer 133. In addition, the wireless communications device 100 may be provided with a structure including a duplexer 133 and a switch to separate the transmit frequency and the receive frequency. For ease of description, an example is provided in which the wireless communications device 100 is provided with a duplex 133 that may separate the transmit frequency and the receive frequency.

The antenna ANT may transmit the transmit signal TX, frequency-separated by the duplexer 133, to an external entity (e.g., another wireless communications device 100). For example, the antenna ANT may include an array antenna, but example embodiments are not limited thereto.

Next, a receive path is described. The antenna ANT may provide a receive signal RX, received from an external entity (e.g., another wireless communications device 100), to the duplexer 133. The duplexer 133 may provide the receive signal RX, received from the antenna ANT, to the LNA 132. However, even when the receive signal RX passes through the duplexer 133, a portion of the above-described OOB emissions caused by the transmit signal may reach the LNA 132.

The LNA 132 may perform amplify the receive signal RX, received from the duplexer 133, with low noise and provide the amplified receive signal RX to the second mixer 124. The second mixer 124 may perform frequency down-conversion to convert a frequency of the receive signal RX from a high-frequency band to a baseband through a frequency signal provided by a local oscillator LO. For example, the second mixer 124 may convert the receive signal RX into a baseband signal through an LO signal.

The receive signal RX corresponding to the baseband signal through such frequency down-conversion may be digitally converted through the ADC 122. The digitally converted receive signal RX may be transmitted to the processor 110.

The processor 110 according to example embodiments may cancel a self-interference signal included in the digitally converted receive signal RX. Although the duplexer 133 provides filtering for the self-interference signal, including external noise, a residual self-interference signal may still be canceled through the processor 110.

For example, the self-interference cancellation device 140 included in the processor 110 may select a nonlinear basis corresponding to the self-interference signal, among a plurality of nonlinear bases for the transmit signal TX, as a subset and obtain a plurality of orthogonal nonlinear bases through orthogonalization on the subset. The self-interference cancellation device 140 may cancel (or reduce) the self-interference signal from the receive signal RX through the plurality of orthogonal nonlinear bases. The self-interference cancellation device 140 may output the receive signal RX_CAN from which the self-interference signal has been canceled.

According to the above-described examples, the self-interference signal may be canceled from the receive signal RX (or reduced) through the self-interference cancellation device 140, resulting in improved reception performance. For example, the wireless communications device 100 may reduce or eliminate correlation between nonlinear bases and reduce computational complexity by selecting nonlinear, caused by the PA 131, as a subset and performing orthogonalization only on the selected subset.

### Modeling of Nonlinear System

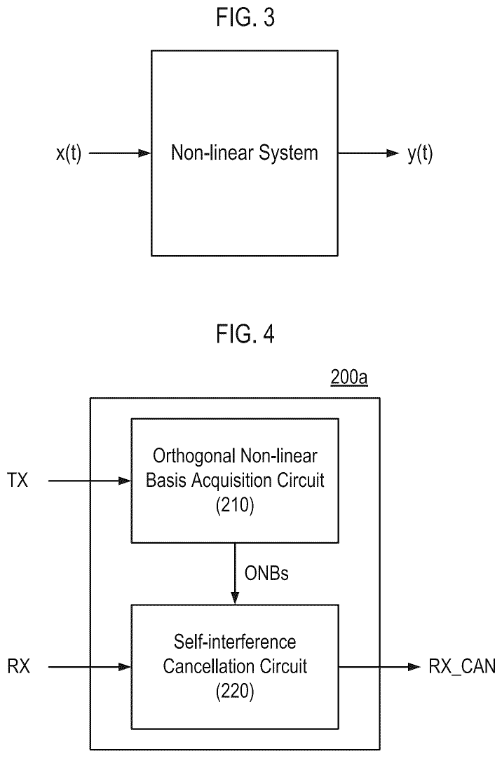

FIG. 3 is a diagram illustrating an example of a nonlinear system.

Referring to FIG. 3, an input signal is converted into an output signal through a nonlinear system. For example, a parallel Hammerstein (PH) model may be defined as a model of the nonlinear system. In the PH model, when the input signal of the nonlinear system is denoted as x(t), an output signal y(t) of the nonlinear system may be defined by the following Equation 1.

$$y ( t ) = {\sum }_{\begin{matrix}k = 1 \\ k odd\end{matrix}}^{K} {c}_{k} {ϕ}_{k} ( x ( t ) ) \qquad Equation 1$$

where k is an index of the order, K is a maximum (or highest) order, cₖ is a nonlinear channel coefficient of a k-th order, and φₖ is a nonlinear basis.

The nonlinear basis φₖ may be defined by the following Equation 2.

$${ϕ}_{k} ( x ) = x {\vert x \vert}^{k - 1} \qquad Equation 2$$

In Equation 1, the input signal x(t) may correspond to a complex baseband equivalent of the transmit signal in FIGS. 1 and 2, and the output signal y(t) may correspond to the complex baseband equivalent of the receive signal (or a self-interference component included in the receive signal) in FIGS. 1 and 2.

The output signal y(t) in an arbitrary (or otherwise, given) time period t₀, t₁, . . . , t_{N-1} having a size of N (where N is a positive integer) may be defined in a vector form as illustrated in the following Equation 3.

$$y = {[ y ( {t}_{0} ) , y ( {t}_{1} ) , ... , y ( {t}_{N - 1} ) ]}^{T} \qquad Equation 3$$

Hereinafter, a nonlinear basis φₖ(x(tₙ)) of each k-th order in an arbitrary time period t₀, t₁, . . . , t_{N-1} is defined as φₖ(tₙ). A matrix A may be defined as illustrated in the following Equation 4.

$$A = [ \begin{matrix}{ϕ}_{1} ( {t}_{0} ) & … & {ϕ}_{K} ( {t}_{0} ) \\ ⋮ & ⋱ & ⋮ \\ {ϕ}_{1} ( {t}_{N - 1} ) & … & {ϕ}_{K} ( {t}_{N - 1} )\end{matrix} ] \qquad Equation 4$$

According to Equations 3 and 4, Equation 1 may be defined in a matrix form as illustrated in the following Equation 5.

$$y = Ac \qquad Equation 5$$

where c=[c₁, c₃, . . . , c_{K}]^{T}. A value ĉ, an estimated value for c, may be defined by the following Equation 6. For example, the estimated value ĉ may be calculated through the least squares (LS).

$$\hat{c} = {( {A}^{H} A )}^{- 1} {A}^{H} y \qquad Equation 6$$

A matrix Φ_{N} for the nonlinear basis may be defined by the following Equation 7, based on some terms of Equation 6 and the size N of an arbitrary (or alternatively, given) time period.

$${Φ}_{N} = \frac{1}{N} {A}^{H} A . \qquad Equation 7$$

where

$${Φ}_{N}^{( i , j )} ,$$

an (i,j)-th element of Φ_{N}, may be defined by the following Equation 8.

$${Φ}_{N}^{( i , j )} = \frac{1}{N} {\sum }_{n = 0}^{N - 1} {ϕ}_{i}^{*} ( {t}_{n} ) {ϕ}_{j} ( {t}_{n} ) \qquad Equation 8$$

When the above-mentioned arbitrary (or alternatively, given) time period t₀, t₁, . . . , t_{N-1} is defined as a time window, Φ_{N} corresponds to a time average covariance matrix within the time window for the random vector φ=[φ₁, φ₃, φ₅, . . . , φ_{K}]^{T}.

An ensemble average covariance matrix Φ of the random vector φ may be defined by the following Equation 9.

$$Φ = E [ {ϕϕ}^{H} ] \qquad Equation 9$$

where E[ ] represents the expectation function. When Equation 9 is stationary, Φ_{N} may converge to Φ of Equation 9 as N increases.

When ĉ is calculated based on Equation 6 to estimate the nonlinear channel coefficient of Equation 1, either Φ_{N} or Φ may be used. In an example in which the input signal x(t) follows a complex Gaussian distribution, Φ typically has a higher condition number or a larger eigenvalue spread. This indicates a higher correlation between the nonlinear bases. When the correlation between nonlinear bases is higher, numerical stability of calculating inverses of Φ_{N} and Φ may be lower.

### Orthogonal Nonlinear Basis

Orthogonal nonlinear bases are defined as being orthogonal to each other. For example, there is no correlation between the nonlinear bases, so that the numerical stability in calculating a nonlinear channel coefficient is higher compared to employing non-orthogonal nonlinear bases. In addition, even when ĉ is estimated using an least mean square (LMS)-based adaptive filter, a decrease in convergence rate or errors in a stable state may be prevented (or reduced). Orthogonal nonlinear bases may be generated (or estimated, calculated, or obtained) through an orthogonalization process on nonlinear bases.

FIG. 4 is a block diagram of a self-interference cancellation device according to example embodiments.

Referring to FIG. 4, a self-interference cancellation device 200a according to example embodiments may include an orthogonal nonlinear basis acquisition circuit 210 and/or a self-interference cancellation circuit 220.

The orthogonal nonlinear basis acquisition circuit 210 may acquire a plurality of nonlinear bases from a transmit signal TX and select a subset including at least a portion of the nonlinear bases. The transmit signal TX may correspond to a complex basis equivalent, and the plurality of nonlinear bases may correspond to φₖ. For example, the orthogonal nonlinear basis acquisition circuit 210 may acquire a plurality of nonlinear bases based on the transmit signal TX and Equation 2.

The orthogonal nonlinear basis acquisition circuit 210 may select at least a portion of the acquired nonlinear bases corresponding to the self-interference signal, as a subset. The selected subset may be defined as {φₖ|some constraint for k}, a set of nonlinear bases for an arbitrary (or otherwise, given) order k.

The orthogonal nonlinear basis acquisition circuit 210 may acquire a plurality of orthogonal nonlinear bases ONBs by performing orthogonalization on the selected subset.

The self-interference cancellation circuit 220 may estimate a self-interference signal based on the plurality of ONBs acquired from the orthogonal nonlinear basis acquisition circuit 210. The self-interference cancellation circuit 220 may cancel (or reduce) the estimated self-interference signal from the receive signal RX and output a receive signal RX_CAN from which the self-interference signal is canceled (or reduced).

Hereinafter, examples of the orthogonal nonlinear basis acquisition circuit 210 and the self-interference cancellation circuit 220 will be described.

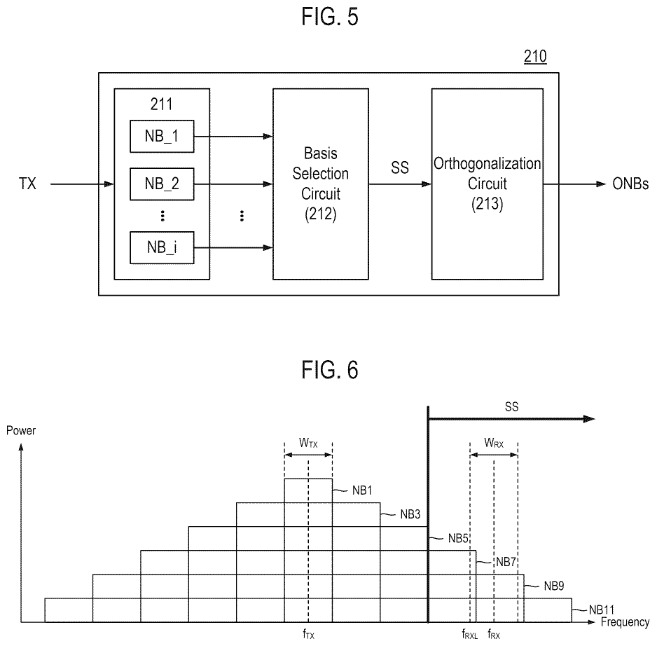

FIG. 5 is a block diagram of an orthogonal nonlinear basis acquisition circuit included in a self-interference cancellation device according to example embodiments, and FIG. 6 is a waveform diagram illustrating the operation of an orthogonal nonlinear basis acquisition circuit according to example embodiments.

Referring to FIG. 5, the orthogonal nonlinear basis acquisition circuit 210 according to example embodiments may include a basis acquisition circuit 211, a basis selection circuit 212, and/or an orthogonalization circuit 213.

The basis acquisition circuit 211 may be configured to acquire i nonlinear bases (where i is a positive integer) from a transmit signal TX. For example, the basis acquisition circuit 211 may acquire a plurality of nonlinear bases, based on the transmit signal TX and Equation 2.

For example, the i nonlinear bases NB_1 to NB_i may have orders from 1 to K (e.g., respectively). For example, when the order of the plurality of nonlinear bases is odd, a nonlinear basis corresponding to order 1 is x and a nonlinear basis corresponding to order 3 is x|x|² (where x is the transmit signal TX, as described above).

The basis selection circuit 212 may be configured to select a subset SS including at least a portion of the acquired nonlinear bases.

In example embodiments, the basis selection circuit 212 may select the subset SS based on at least one of a frequency bandwidth, a center frequency, or the extent to which out-of-band (OOB) emission caused by the transmission signal TX of a wireless communication device (for example FIGS. 1 and 2) affects a receive signal RX set for at least one of the transmission signal TX and/or the receive signal RX.

The frequency bandwidth and/or the center frequency may be based on network scenarios defined by a 3rd Generation Partnership Project (3GPP), for example, low band, mid band, high band, frequency range 1 (FR1), FR2, or the like.

In example embodiments, the basis selection circuit 212 may select a subset SS based on a gap between a center frequency of the transmit signal TX and a center frequency of the receive signal RX and a bandwidth of each signal. The basis selection circuit 212 may select at least a portion of the plurality of nonlinear bases having an upper frequency, higher than or equal to a lower frequency limit within the bandwidth of the receive signal RX, as the subset SS.

In FIG. 6, the power of a signal per frequency is illustrated. A center frequency of a complex basis equivalent of a transmit signal is f_{Tx}, and a bandwidth of the complex basis equivalent of the transmit signal is W_{Tx}. A center frequency of a complex basis equivalent of a receive signal is f_{Rx}, and a bandwidth of the complex basis equivalent of the receive signal is W_{Rx}. In addition, an example in which f_{Tx}<f_{Rx} is provided, and a nonlinear basis 1 to a nonlinear basis 11 (for example, K=11) are taken into consideration. In addition, a bandwidth of each nonlinear basis may be defined as k*W_{Tx}.

As illustrated, not all nonlinear bases may affect the band of the receive signal. For example, not all nonlinear bases may act as self-interference signals for the receive signal. For example, nonlinear bases corresponding to some orders may not affect the receive signal.

For example, a nonlinear basis 7 NB7 corresponding to a nonlinear basis of order 7 and nonlinear bases NB9 and NB11 of orders higher than 7 clearly affect a bandwidth of the receive signal. Therefore, the nonlinear bases NB7, NB9, and NB11 may be selected as a subset SS.

However, the power of nonlinear bases of orders less than 7, for example, nonlinear of bases having order 5 or less NB1, NB3, and NB5, does not overlap the bandwidth W_{Rx} the receive signal. For example, nonlinear bases of order 5 or less NB1, NB3, and NB5 do not act as self-interference signals for the received signal.

Returning to FIG. 5, the basis selection circuit 212 according to example embodiments may select at least some nonlinear bases as a subset SS, where each selected nonlinear basis has an upper-limit frequency (for example, a highest frequency within the bandwidth k*W_{Tx} of each nonlinear basis) that is higher than or equal to a lower-limit frequency (for example, f_{RXL} of FIG. 6) within the bandwidth of the receive signal. Alternatively or additionally, in example embodiments, the basis selection circuit 212 may select at least some nonlinear bases having order k (where k is a positive integer) satisfying a condition as a subset SS. For example, the condition may be defined by Equation 10.

$$k \geq \frac{2 ( {f}_{Rx} \to {f}_{Tx} ) - {W}_{Rx}}{{W}_{Tx}} \qquad Equation 10$$

The basis selection circuit 212 may find k defined for a bandwidth of a nonlinear basis having an upper-limit frequency higher than or equal to a lower-limit frequency limit within the bandwidth of the receive signal RX, based on Equation 10.

For example, when an n25 frequency band and an intra-band non-contiguous (IBNC) CA network scenario are taken into consideration, f_{Tx} may be 1905 MHz, f_{Rx} may be 1960 MHz, and W_{Tx} and W_{Rx} may be 20 MHz. According to Equation 10, k may be an odd number set greater than or equal to 5 to less than or equal to K. Therefore, the basis selection circuit 212 may select nonlinear bases having order k corresponding to the odd number set equal to or greater than 5 to less than or equal to K, as a subset SS. The subset SS may be S={φ₅, φ₇, . . . φ_{K}}.

Alternatively or additionally, in example embodiments, when a plurality of nonlinear bases measured in a calibration mode performed through a test signal are provided or received, the basis selection circuit 212 may select at least some of the measured nonlinear bases overlapping the bandwidth of the receive signal RX, as a subset SS. For example, the basis selection circuit 212 may select some nonlinear bases acting as self-interference signals, among the nonlinear bases measured through the test signal. The subset SS may include nonlinear bases of arbitrarily (or otherwise, given) non-continuous orders.

For example, when the orders of the nonlinear bases affecting the bandwidth of the receive signal RX, among the measured nonlinear bases, are 3, 7, and 11, the subset SS may be {φ₃, φ₇, φ₁₁}.

The basis selection circuit 212 may adaptively select the subset SS based on selection criteria according to the above-described examples (for example, a frequency bandwidth, a center frequency, or the like).

The orthogonalization circuit 213 may be configured to perform orthogonalization on the subset SS selected from the basis selection circuit 212. For example, the orthogonalization circuit 213 may orthogonalize only nonlinear bases included in the subset SS, and at least one nonlinear basis that is not included in the subset SS (for example, the remaining nonlinear bases that are not selected through the basis selection circuit 212) may be excluded from the orthogonalization target.

When the number of nonlinear bases included in the subset SS is M (where M is a positive integer), an element of the subset SS may be defined as φ_{S,0}, . . . , φ_{S,M-1}. Each element is a nonlinear basis corresponding to an arbitrary (or otherwise, given) order l. The order l is selected as an order of the nonlinear bases included in the subset SS.

The orthogonalization circuit 213 may arrange M nonlinear bases included in the subset SS in ascending order with respect to their orders, as a preprocessing (or processing) operation on orthogonalization. In this case, φ_{S,0}, . . . , φ_{S,M-1} may represent the nonlinear bases arranged in ascending order with respect to their orders.

For example, when the orders of the nonlinear bases included in the subset SS are odd numbers from 5 to K, the subset SS may be S={φ₅, φ₇, . . . φ_{K}}, and φ_{S,0}, . . . , φ_{S,M-1} representing an element of the subset SS may correspond to φ_{S,0}=φ₅, φ_{S,1}=φ₇, . . . , φ_{S,M-1}=φ_{K}.

According to example embodiments, the orthogonalization circuit 213 may perform orthogonalization by applying various orthogonalization techniques to the subset SS. For example, the orthogonalization techniques may include Gram-Schmidt, Householder transformation, Givens rotation, singular value decomposition (SVD), or the like. The orthogonalization may allow φ_{S,0}, . . . , φ_{S,M-1} to be transformed into ψ_{S,0}, . . . , ψ_{S,M-1}, a plurality of orthogonal nonlinear bases (ONBs).

For example, the orthogonal nonlinear basis acquisition circuit 210 may acquire a plurality of ONBs based on performing the Gram-Schmidt technique on the subset SS. For example, the orthogonalization circuit 213 may perform the Gram-Schmidt technique on the subset SS through the following operations:
(1) The orthogonalization circuit 213 defines ψ_{S,0}=φ_{S,0}.
(2) The orthogonalization circuit 213 defines

$${ψ}_{S , 1} = {ϕ}_{S , 1} - \frac{E [ {ϕ}_{S , 1}^{*} {ψ}_{S , 0} ]}{E [ {\vert {ψ}_{S , 0} \vert}^{2} ]} {ψ}_{S , 0} .$$

Here, E[ ] is a function for calculating the expectation value.
(3) The orthogonalization circuit 213 defines

$${ψ}_{S , 2} = {ϕ}_{S , 2} - \frac{E [ {ϕ}_{S , 2}^{*} {ψ}_{S , 1} ]}{E [ {\vert {ψ}_{S , 1} \vert}^{2} ]} {ψ}_{S , 1} - \frac{E [ {ϕ}_{S , 2}^{*} {ψ}_{S , 0} ]}{E [ {\vert {ψ}_{S , 0} \vert}^{2} ]} {ψ}_{S , 0} .$$

(4) The orthogonalization circuit 213 defines an orthogonal nonlinear basis for an arbitrary (or otherwise, given) order l, and defines the orthogonal nonlinear basis

$${ψ}_{S , M - 1} = {ϕ}_{S , M - 1} - \frac{E [ {ϕ}_{S , M - 1}^{*} {ψ}_{S , M - 2} ]}{E [ {\vert {ψ}_{S , M - 2} \vert}^{2} ]} {ψ}_{S , M - 2} - … - \frac{E [ {ϕ}_{S , M - 1}^{*} {ψ}_{S , 0} ]}{E [ {\vert {ψ}_{S , 0} \vert}^{2} ]} {ψ}_{S , 0}$$

for the last order M.

In the Gram-Schmidt technique based on the above-described operations (1) to (4), a coefficient for an orthogonal nonlinear basis term having an index less than j (where j is a positive integer) that defines a j-th orthogonal nonlinear basis (for example, in the case of a second orthogonal nonlinear basis, a coefficient

$$\frac{E [ {ϕ}_{S , 1}^{*} {ψ}_{S , 0} ]}{E [ {\vert {ψ}_{S , 0} \vert}^{2} ]}$$

for a first orthogonal nonlinear basis term) may be a projected element.

The orthogonalization circuit 213 may obtain an orthogonal matrix through the Gram-Schmidt technique and obtain orthogonal nonlinear bases based on the orthogonal matrix.

In an example in which the transmit signal TX follows a complex Gaussian distribution (for example, x˜CN(0,1)) and the orders of the subset SS are 5, 7, and 9, the orthogonalization circuit 213 may obtain orthogonal nonlinear bases based on the following Equation 11.

$${\underbrace{[ \begin{matrix}{ψ}_{S , 0} \\ {ψ}_{S , 1} \\ {ψ}_{S , 2}\end{matrix} ]}}_{{ψ}_{S}} = {\underbrace{[ \begin{matrix}1 & 0 & 0 \\ - 6 & 1 & 0 \\ 42 & - 14 & 1\end{matrix} ]}}_{{F}_{S}} {\underbrace{[ \begin{matrix}{ϕ}_{S , 0} \\ {ϕ}_{S , 1} \\ {ϕ}_{S , 2}\end{matrix} ]}}_{{ϕ}_{S}} \qquad [ Equation 11 ]$$

In Equation 11, the orthogonal matrix F_{S} may be a matrix defined by coefficients for the orthogonal nonlinear basis items obtained using the above-described Gram-Schmidt technique. ψ_{S} is an orthogonal nonlinear basis defined as the product of the orthogonal matrix F_{S} and the nonlinear basis matrix φ_{S}.

The orthogonalization circuit 213 may adaptively obtain orthogonal nonlinear bases based on the adaptively selected subset SS.

In the above-described example, a covariance matrix Ψ_{S} of the orthogonal nonlinear basis ψ_{S} may be used to check whether the orthogonal nonlinear basis ψ_{S} is orthogonal. For example, Ψ_{S} may be defined based on the following Equation 12.

$$\begin{matrix}{Ψ}_{S} = E [ {ψ}_{S} {ψ}_{S}^{H} ] \\ = E [ {F}_{S} {ψ}_{{S}^{}} {ψ}_{{S}^{}}^{H} {F}_{S}^{H} ] \\ = {F}_{S} E [ {ϕ}_{S} {ϕ}_{S}^{H} ] {F}_{S}^{H}\end{matrix} \qquad [ Equation 12 ]$$

The covariant matrix Ψ_{S} for the above-described example (Equation 11) may be calculated as Equation 13.

$$\begin{matrix}{Ψ}_{S} = {[ \begin{matrix}1 & 0 & 0 \\ - 6 & 1 & 0 \\ 42 & - 14 & 1\end{matrix} ] [ \begin{matrix}120 & 720 & 5040 \\ 720 & 5040 & 40320 \\ 5040 & 40320 & 362880\end{matrix} ] [ \begin{matrix}1 & 0 & 0 \\ - 6 & 1 & 0 \\ 42 & - 14 & 1\end{matrix} ]}^{T} \\ = [ \begin{matrix}120 & 0 & 0 \\ 0 & 720 & 0 \\ 0 & 0 & 10080\end{matrix} ]\end{matrix} \qquad [ Equation 13 ]$$

The elements other than the diagonal elements are 0, so that the orthogonality of the orthogonal nonlinear bases may be checked.

The orthogonal nonlinear basis acquisition circuit 210 according to the above-described examples may perform orthogonalization by selecting only a nonlinear basis corresponding to a self-interference component, among the nonlinear bases. Accordingly, the number of bases based on orthogonalization calculation may be reduced, so that the computational complexity may be reduced. In addition, the orthogonal nonlinear basis acquisition circuit 210 may enhance estimation accuracy by excluding bases having no impact on reception performance.

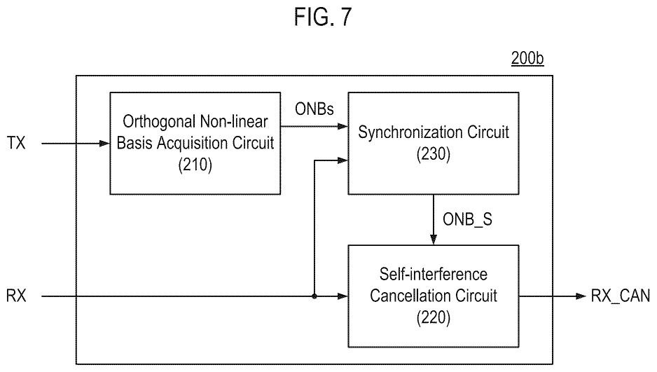

FIG. 7 is a block diagram of a self-interference cancellation device according to example embodiments. Hereinafter, detailed descriptions redundant or similar to those provided in the above-described examples are omitted to enhance clarity and avoid repetition.

Referring to FIG. 7, a self-interference cancellation device 200b according to example embodiments may further include a synchronization circuit 230 in addition to the orthogonal nonlinear basis acquisition circuit 210 and the self-interference cancellation circuit 220.

The synchronization circuit 230 may be configured to obtain a plurality of synchronized orthogonal nonlinear bases ONBs based on time synchronization of a plurality of orthogonal nonlinear bases ONBs and a receive signal RX. The synchronization circuit 230 may receive the plurality of orthogonal nonlinear bases ONBs provided from the nonlinear basis acquisition circuit 210 and synchronize time (or timing) of the plurality of orthogonal nonlinear bases ONBs with the receive signal RX. For example, the plurality of orthogonal nonlinear bases ONBs may be time-synchronized with the received signal RX.

In addition, the self-interference cancellation circuit 220 may estimate a self-interference signal based on the plurality of synchronized orthogonal nonlinear bases ONB_S and output a received signal RX_CAN form which the self-interference signal is canceled (or reduced).

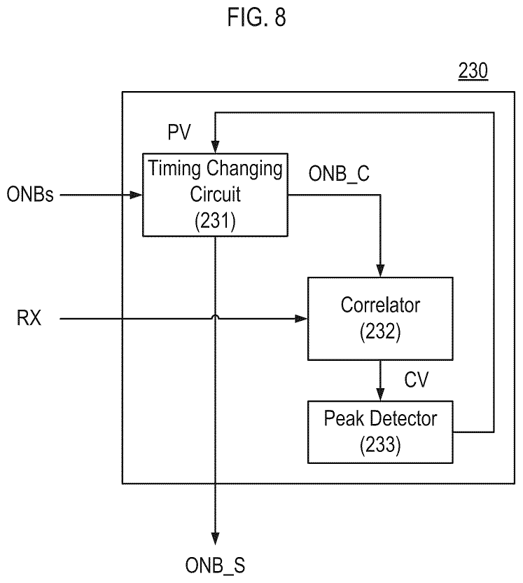

FIG. 8 is a block diagram of a synchronization circuit of FIG. 7 according to example embodiments.

Referring to FIG. 8, the synchronization circuit 230 according to example embodiments may include a timing changing circuit 231, a correlator 232, and/or a peak detector 233.

The timing changing circuit 231 may change timing of the plurality of orthogonal nonlinear bases ONBs. For example, the timing changing circuit 231 may delay the plurality of orthogonal nonlinear bases ONBs by specific time delay values. The delayed orthogonal nonlinear bases ONB_C may be provided to the correlator 232.

The correlator 232 receives a received signal RX and a changed orthogonal nonlinear basis ONB_C. For example, the receive signal RX may be provided through a receiving path. The correlator 232 may calculate a correlation value CV through a correlation operation on the receive signal RX and the changed orthogonal nonlinear basis ONB_C. The correlator 232 may provide the correlation value CV based on the correlation operation to the peak detector 233.

The peak detector 233 may find a correlation value CV having a peak value PV, among the correlation values CV, and provides the found correlation value CV to the timing changing circuit 231. The timing changing circuit 231 may output a converted orthogonal nonlinear basis corresponding to the peak value PV as a synchronized orthogonal nonlinear basis ONB_S.

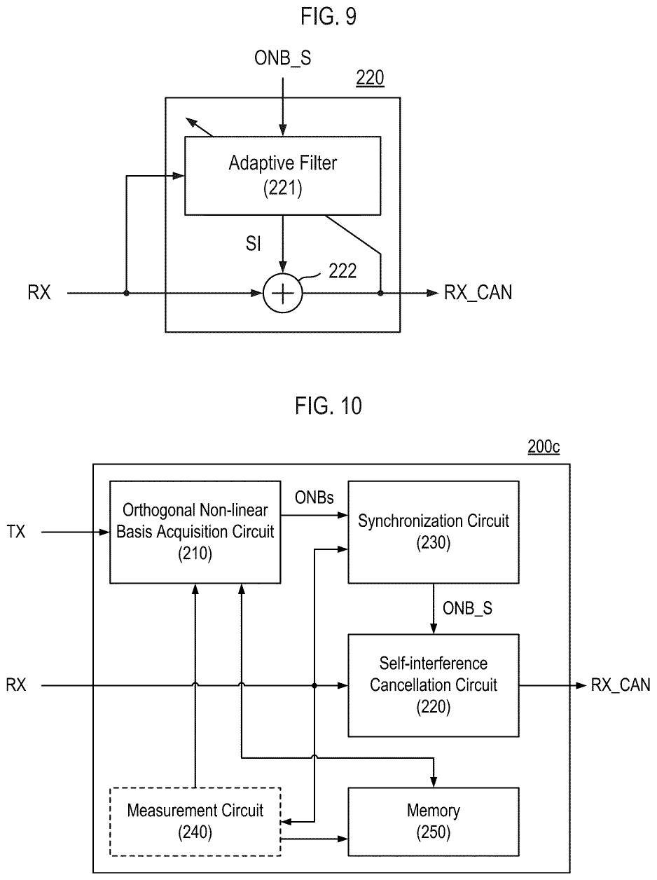

FIG. 9 is a block diagram of a self-interference cancellation circuit according to example embodiments.

Referring to FIG. 9, a self-interference cancellation circuit 220 according to example embodiments may include an adaptive filter 221 and/or an adder 222.

The self-interference cancellation circuit 220 may estimate a nonlinear channel coefficient, defined for a synchronized orthogonal nonlinear basis ONB_S, based on the adaptive filter 221. The adaptive filter 221 may adaptively estimate a nonlinear channel coefficient that significantly reduces an error signal defined as a difference between a receive signal RX and a self-interference signal.

The self-interference cancellation circuit 220 may estimate the output of a nonlinear model defined based on an adaptively estimated nonlinear channel coefficient and a plurality of orthogonal nonlinear bases ONBs as a self-interference signal SI. Thereafter, the self-interference cancellation circuit 220 may cancel the self-interference signal SI from the receive signal RX through the adder 222 and ultimately output a receive signal RX_CAN from which the self-interference signal SI is canceled.

An actual self-interference signal y(t) included in the receive signal RX may be defined by the following Equation 14.

$$y ( t ) = {\sum }_{k = 0}^{M - 1} {b}_{k} {ψ}_{S , k} ( x ( t ) ) \qquad [ Equation 14 ]$$

where bₖ is a nonlinear channel coefficient corresponding to an orthogonal nonlinear basis ψ_{S,k}.

The self-interference cancellation circuit 220 may estimate the output of the nonlinear model based on the following Equation 15 as a nonlinear channel coefficient through the adaptive filter 221. According to example embodiments, the relationship defined by Equation 15 may represent the nonlinear model.

$$\tilde{y} ( t ) = {\sum }_{k = ( )}^{M - 1} {\tilde{b}}_{k} {ψ}_{S , k} ( x ( t ) ) \qquad [ Equation 15 ]$$

where \tilde{y}(t) is an estimated self-interference signal and \tilde{b}ₖ is an estimated nonlinear channel coefficient.

An error signal may be defined by the following Equation 16.

$$e ( t ) = y ( t ) - \tilde{y} ( t ) \qquad [ Equation 16 ]$$

The self-interference cancellation circuit 220 may adaptively estimate \tilde{b}ₖ that significantly reduces the error signal based on Equation 16, and ultimately cancel the self-interference signal SI corresponding to the estimated \tilde{b}ₖ from the receive signal RX.

The self-interference cancellation circuit 220 according to the above-described examples may have higher numerical stability for nonlinear channel coefficient calculation by estimating the nonlinear channel coefficient based on the synchronized orthogonal nonlinear basis ONB_S.

FIG. 10 is a block diagram of a self-interference cancellation device according to example embodiments.

Referring to FIG. 10, a self-interference cancellation device 200c according to example embodiments may further include a measurement circuit 240 and/or a memory 250 in addition to the orthogonal nonlinear basis acquisition circuit 210, the self-interference cancellation circuit 220, and/or the synchronization circuit 230.

The measurement circuit 240 may measure, for example, a plurality of nonlinear bases from the receive signal RX in a calibration mode performed through a test signal. The measurement may be performed for each frequency bandwidth, center frequency, and/or wireless communications device.

The measurement circuit 240 may store the plurality of measured nonlinear bases in the memory 250 and/or provide the plurality of measured nonlinear bases to the orthogonal nonlinear basis acquisition circuit 210.

The orthogonal nonlinear basis acquisition circuit 210 may receive the plurality of measured nonlinear bases from the measurement circuit 240 and select a subset corresponding to the self-interference signal from the plurality of measured nonlinear bases. The orthogonal nonlinear basis acquisition circuit 210 may store the selected subset in the memory 250. The orthogonal nonlinear basis acquisition circuit 210 may read the subset stored in the memory 250 and perform orthogonalization on the read subset.

The memory 250 may be configured to store the plurality of measured nonlinear bases and/or the subset.

According to example embodiments, the measurement circuit 240 may be provided inside the wireless communications device according to the above-described examples. As a result, the measurement circuit 240 may be excluded from the self-interference cancellation device 200c.

The self-interference cancellation device 200c according to the above-described examples may store the nonlinear bases and/or subsets, measured in the calibration mode, in the memory 250, and may read and use the stored nonlinear bases and/or subsets each time orthogonalization is performed. Accordingly, the orthogonalization may be performed more efficiently.

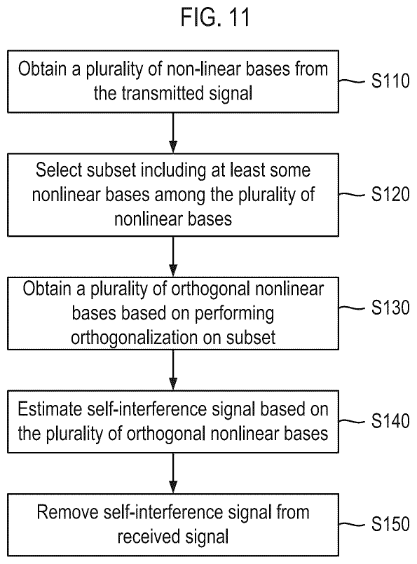

FIG. 11 is a flowchart illustrating a method of a self-interference cancellation device according to example embodiments.

Referring to FIG. 11, in operation S110, a self-interference cancellation device may acquire (or obtain) a plurality of nonlinear bases from a transmit signal. For example, operation S110 may be performed based on the transmit signal and Equation 2. In operation S110, acquiring a nonlinear basis for an arbitrary (or otherwise, given) order k based on Equation 2 may be iteratively performed for orders from 1 to K.

In operation S120, the self-interference cancellation device may select a subset including at least a portion of the plurality of nonlinear bases. In example embodiments, operation S120 may be performed based on at least one of a frequency bandwidth or a center frequency set for at least one of the transmit signal and/or a receive signal. In example embodiments, in operation S120, the self-interference cancellation device may select, as a subset, at least a portion of nonlinear bases having an upper-limit frequency higher than or equal to a lower-limit frequency within the bandwidth of the receive signal, from among the plurality of nonlinear bases.

In operation S130, the self-interference cancellation device may acquire (or obtain) a plurality of orthogonal nonlinear bases based on performing orthogonalization on the subset. Operation S130 may be performed only on nonlinear bases included in the subset. In operation S130, acquiring an orthogonal nonlinear basis for an arbitrary (or alternatively, given) order l may be iteratively performed.

In operation S140, the self-interference cancellation device may estimate a self-interference signal based on the plurality of orthogonal nonlinear bases.

In operation S150, the self-interference cancellation device may cancel the self-interference signal from the receive signal.

In example embodiments, the method may further include an operation of acquiring a plurality of synchronized orthogonal nonlinear bases, based on time synchronization of the plurality of orthogonal nonlinear bases and the receive signal. The operation of estimating the self-interference signal may use the plurality of synchronized orthogonal nonlinear bases.

In example embodiments, the method may further include an operation of estimating a nonlinear channel coefficient defined for the plurality of orthogonal nonlinear bases based on an adaptive filter. The operation of estimating the self-interference signal may estimate an output of a nonlinear model defined based on the nonlinear channel coefficient and the plurality of orthogonal nonlinear bases as the self-interference signal.

According to the above-described method, the self-interference signal may be canceled from the receive signal (or reduced) to improve reception performance. In addition, operation S130 of performing the orthogonalization is performed only on the subset, so that computational complexity may be reduced. In addition, a correlation between the nonlinear bases is reduced or removed through the orthogonalization, so that the numerical stability of nonlinear channel coefficient estimation may be improved.

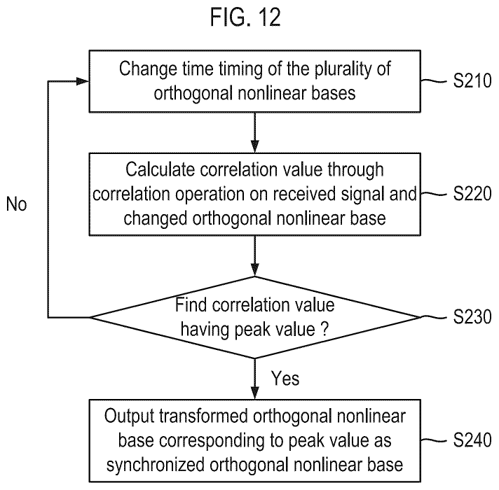

FIG. 12 is a flowchart illustrating a synchronization method according to example embodiments.

Referring to FIG. 12, in operation S210, a self-interference cancellation device may change a timing of a plurality of orthogonal nonlinear bases. For example, the plurality of orthogonal nonlinear bases may be delayed by a specific time delay value unit through operation S210.

In operation S220, the self-interference cancellation device may calculate a correlation value through a correlation operation on a received signal and the changed orthogonal nonlinear bases.

In operation S230, the self-interference cancellation device may find a correlation value having a peak value, among correlation values calculated through operation S220. When (e.g., in response to determining that) the peak value is not identified in operation S230, operations S210 to S230 may be iteratively performed until a peak value is identified.

When (e.g., in response to determining that) a peak value is identified in operation S230, the flow proceeds to operation S240 in which the self-interference cancellation device may output the changed orthogonal nonlinear basis corresponding to the peak value as a synchronized orthogonal nonlinear basis.

The synchronization method according to the above-described method is performed only on a subset, so that the computational complexity of synchronization may be reduced.

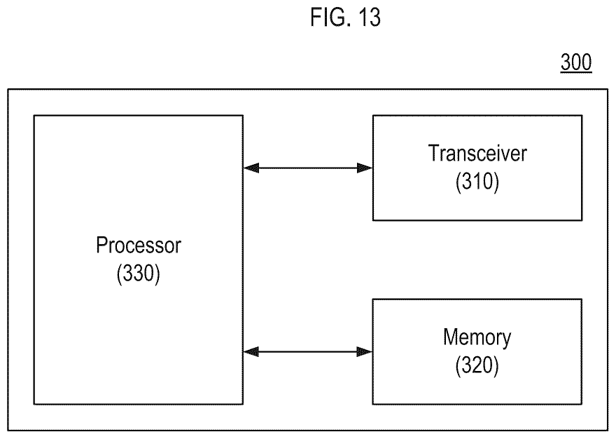

FIG. 13 is a block diagram of a device according to example embodiments.

Referring to FIG. 13, a device 300 may include a transceiver 310, a memory 320, and/or a processor 330. However, the components of the device 300 are not limited to the above-described example. For example, the device 300 may include more components or fewer components than the above-described components. In addition, at least a portion or the entirety of the transceiver 310, memory 320, and processor 330 may be implemented in the form of a single chip.

In example embodiments, the transceiver 310 may transmit and receive signals to and from a terminal or a base station. The transmitted and received signals may include control information and data.

According to example embodiments, the transceiver 310 may include an RF transmitter up-converting and amplifying a frequency of a transmitted signal, and an RF receiver amplifying a receive signal with low noise and down-converting the frequency. In addition, the transceiver 310 may receive a signal through a wireless channel and output the received signal to the processor 330, and may transmit a signal output from the processor 330 through a wireless channel.

The memory 320 may include one or more memories and be connected to the processor 330, and may store various types of information related to the operation of the processor 330. For example, the memory 320 may store software code including at least one instruction for performing some or all of the processes controlled by the processor 330 or for performing the descriptions, functions, procedures, proposals, methods, and/or operational flowcharts related to the wireless communications device or the self-interference cancellation device in the present disclosure.

In example embodiments, the memory 320 may store various types of data, generated, acquired, defined, or processed in the present disclosure, including a plurality of measured nonlinear bases and a subset.

The processor 330 may be provided in one or more to control the memory 320, and may be configured to execute at least one instruction stored in the memory 320 to implement the descriptions, functions, procedures, proposals, methods, and/or operational flowcharts related to the wireless communications device or the self-interference cancellation device according to example embodiments. In addition, the processor 330 may provide various operations according to various examples based on the instructions stored in the memory 320. In addition, the processor 330 may process information stored in the memory 320 to generate data.

In example embodiments, the processor 330 may select a subset corresponding to a self-interference signal from a plurality of nonlinear bases of a transmit signal transmitted through the transceiver 310, and acquire orthogonal nonlinear bases through orthogonalization of the subset. The processor 330 may estimate and cancel the self-interference signal based on the orthogonal nonlinear bases.

In example embodiments, the processor 330 may measure nonlinear bases in a calibration mode and store the measured nonlinear bases or the subset in the memory 320. The processor 330 may read the measured nonlinear bases or the subset from the memory 320 and perform orthogonalization using read data. Acquisition of nonlinear bases and selection of a subset for each transmit signal may not be required to reduce the complexity of the self-interference cancellation operation. According to example embodiments, after canceling the self-interference signal from the receive signal to obtain an updated receive signal, the processor 330 perform one or more further operation(s) based on the updated receive signal. For example, the one or more further operation(s) may include one or more of providing the updated receive signal to an application executing on the device 300 (e.g., for performing a service based on data provided in the updated receive signal), storing the updated receive signal (e.g., in the memory 320), sending a response signal to an external device (e.g., using the same components as, or similar components to, those discussed in connection with FIG. 2) based on data provided in the updated receive signal, etc.

As set forth above, according to example embodiments, a self-interference cancellation device capable of cancelling self-interference from a receive signal, a wireless communications device including the same, and a method may be provided.

Conventional devices and methods for performing simultaneous or contemporaneous wireless transmission and reception experience excessive self-interference. For example, a transmission band of the conventional devices and methods may overlap a reception band, and the transmission in the transmission band may directly result in self-interference in the reception band. In another example, spectral emissions of a transmission, resulting from nonlinearity in a transmission or reception radio frequency chain, may overlap the reception band and result in self-interference even in scenarios in which the transmission and reception bands do not overlap. As a result of the above-described self-interference, the conventional devices and methods experience degraded reception performance.

However, according to example embodiments, improved devices and methods are provided for performing simultaneous or contemporaneous wireless transmission and reception. For example, the improved devices and methods include selecting nonlinear bases of a received signal that act as self-interference, orthogonalizing the selected nonlinear bases to obtain mutually orthogonal nonlinear bases, and canceling (or reducing) a self-interference signal based on the orthogonalized nonlinear bases. Accordingly, the improved devices and methods overcome the deficiencies of the conventional devices and methods to at least improve reception performance.

According to example embodiments, operations described herein as being performed by the wireless communications device 100, the processor 110, the RFIC 120, the FEM 130, the self-interference cancellation device 140, the DAC 121, the ADC 122, the first mixer 123, the second mixer 124, the PA 131, the LNA 132, the duplexer 133, the local oscillator LO, the self-interference cancellation device 200a, the orthogonal nonlinear basis acquisition circuit 210, the self-interference cancellation circuit 220, the basis acquisition circuit 211, the basis selection circuit 212, the orthogonalization circuit 213, the self-interference cancellation device 200b, the synchronization circuit 230, the timing changing circuit 231, the correlator 232, the peak detector 233, the adaptive filter 221, the adder 222, the self-interference cancellation device 200c, the measurement circuit 240, the device 300, the transceiver 310, and/or the processor 330 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 250, the memory 320, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

While example embodiments have been shown and described above, it will be apparent to those skilled in the art that modifications and variations could be made without departing from the scope of the present inventive concepts as defined by the appended claims.

What is claimed is:

1. A self-interference cancellation device comprising:
processing circuitry configured to,
acquire a plurality of nonlinear bases from a transmit signal,
select a subset including at least a portion of the plurality of nonlinear bases,
acquire a plurality of orthogonal nonlinear bases based on performing orthogonalization on the subset,
estimate a self-interference signal based on the plurality of orthogonal nonlinear bases, and
cancel the self-interference signal from a receive signal.

2. The self-interference cancellation device of claim 1, wherein the processing circuitry is configured to:
acquire a plurality of synchronized orthogonal nonlinear bases based on time synchronization of the plurality of orthogonal nonlinear bases and the receive signal; and
estimate the self-interference signal based on the plurality of synchronized orthogonal nonlinear bases.

3. The self-interference cancellation device of claim 1, wherein
the processing circuitry is configured to select the subset based on at least one of a frequency bandwidth or a center frequency, the at least one of the frequency bandwidth or the center frequency being set for at least one of the transmit signal or the receive signal.

4. The self-interference cancellation device of claim 3, wherein
processing circuitry is configured to select as the subset first nonlinear bases having an upper-limit frequency higher than or equal to a lower-limit frequency within a bandwidth of the receive signal, the plurality of nonlinear bases including the first nonlinear bases.

5. The self-interference cancellation device of claim 3, wherein
the processing circuitry is configured to select as the subset first nonlinear bases having a degree k satisfying a condition, the plurality of nonlinear bases including the first nonlinear bases, k being a positive integer,
the condition being defined as
$$k \geq \frac{2 ( {f}_{Rx} - {f}_{Tx} ) - {W}_{Rx}}{{W}_{Tx}} ,$$
f_{Rx} being a center frequency of a complex baseband equivalent of the receive signal, f_{TX} being a center frequency of a complex baseband equivalent of the transmit signal, W_{RX} being a bandwidth of the receive signal, and W_{TX} being a bandwidth of the transmit signal.

6. The self-interference cancellation device of claim 1, wherein
the processing circuitry is configured to acquire the plurality of orthogonal nonlinear bases by performing a Gram-Schmidt technique on the subset.

7. The self-interference cancellation device of claim 1, wherein
the plurality of nonlinear bases have degrees ranging from 1 to K, K being a positive integer; and
the at least the portion of the nonlinear bases has a degree k, k being a positive integer smaller than or equal to K.

8. The self-interference cancellation device of claim 1, wherein the processing circuitry is configured to:
estimate nonlinear channel coefficients defined for the plurality of orthogonal nonlinear bases based on an adaptive filter; and
estimate the self-interference signal as an output of a nonlinear model defined based on the nonlinear channel coefficients and the plurality of orthogonal nonlinear bases.

9. The self-interference cancellation device of claim 8, wherein
the adaptive filter is configured to estimate the nonlinear channel coefficients to reduce an error signal defined as a difference between the receive signal and the self-interference signal.

10. The self-interference cancellation device of claim 3, wherein
the processing circuitry is configured to receive the plurality of nonlinear bases measured in a calibration mode performed using a test signal.

11. The self-interference cancellation device of claim 10, wherein
the processing circuitry is configured to select as the subset first nonlinear bases overlapping a bandwidth of the receive signal, the plurality of nonlinear bases including the first nonlinear bases.

12. The self-interference cancellation device of claim 1, further comprising:
a memory configured to store the subset,
wherein the processing circuitry is configured to,
read the subset stored in the memory, and
perform the orthogonalization on the subset read in the memory.

13. A method comprising:
acquiring a plurality of nonlinear bases from a transmit signal;
selecting a subset including at least a portion of the plurality of nonlinear bases;
acquiring a plurality of orthogonal nonlinear bases based on performing orthogonalization on the subset;
estimating a self-interference signal based on the plurality of orthogonal nonlinear bases; and
canceling the self-interference signal from a receive signal.

14. The method of claim 13, further comprising:
acquiring a plurality of synchronized orthogonal nonlinear bases based on time synchronization between the plurality of orthogonal nonlinear bases and the receive signal,
wherein the estimating of the self-interference signal estimates the self-interference signal using the plurality of synchronized orthogonal nonlinear bases.

15. The method of claim 13, wherein
the selecting of the subset is based on at least one of a frequency bandwidth or a center frequency, the at least one of the frequency bandwidth or the center frequency being set for at least one of the transmit signal or the receive signal.

16. The method of claim 15, wherein
the selecting of the subset comprises selecting as the subset first nonlinear bases having an upper-limit frequency higher than or equal to a lower-limit frequency within a bandwidth of the receive signal, the plurality of nonlinear bases including the first nonlinear bases.

17. The method of claim 13, wherein
the plurality of nonlinear bases have degrees ranging from 1 to K, K being a positive integer; and
the at least the portion of the nonlinear bases has a degree k, k being a positive integer smaller than or equal to K.

18. The method of claim 13, further comprising:
estimating nonlinear channel coefficients defined for the plurality of orthogonal nonlinear bases based on an adaptive filter,
wherein the estimating of the self-interference signal estimates as the self-interference signal an output of a nonlinear model defined based on the nonlinear channel coefficients and the plurality of orthogonal nonlinear bases.

19. A wireless communications device comprising:
a front-end module (FEM) configured to,
separate a transmit channel and a receive channel,
transmit a transmit signal through the transmit channel, and
receive a receive signal through the receive channel;
a radio-frequency integrated chip (RFIC) configured to perform frequency conversion and analog-to-digital conversion on the transmit signal and the receive signal; and
processing circuitry configured to,
acquire a plurality of nonlinear bases from the transmit signal, the transmit signal being a digital signal,
select a subset including at least a portion of the plurality of nonlinear bases,
acquire a plurality of orthogonal nonlinear bases based on performing orthogonalization on the subset,
estimate a self-interference signal based on the plurality of orthogonal nonlinear bases, and
cancel the self-interference signal from the receive signal.

20. The wireless communications device of claim 19, wherein
the processing circuitry is configured to select the subset based on at least one of a frequency bandwidth or a center frequency, the at least one of the frequency bandwidth or the center frequency being set for at least one of the transmit signal or the receive signal.
